(19) United States
(12) Patent Application Publication
(10) Pub. No.: US 2016/0341944 A1
(43) Pub. Date: Nov. 24, 2016

(54) Device for concentrating energy from sunrays, artificial light beams or electromagnetic radiation

(71) Applicant: André Luiz Esteves PALMEIRA, Rio de Janeiro (BR)

(72) Inventor: André Luiz Esteves PALMEIRA, Rio de Janeiro (BR)

(21) Appl. No.: 14/782,995

(22) PCT Filed: Apr. 4, 2014
(86) PCT No.: PCT/BR2014/000109

§ 371 Date: Oct. 7, 2015

(30) Foreign Application Priority Data
Apr. 8, 2013 (BR) 1020130084295

(51) Int. Cl. G02B 19/00; G02B 7/02

(52) U.S. Cl. CPC G02B 19/0014; G02B 19/0042; G02B 19/0047; G02B 7/021

(57) ABSTRACT

The invention relates to a device for concentrating the energy from solar or artificial light rays, and from electromagnetic radiation, more specifically to an energy concentration device (1) for capturing, magnifying and projecting light rays or another electromagnetic radiation from artificial sources or the sun; the energy concentration device (1) comprises various combinations and arrangements of two or more magnifying lenses (L) of various shapes, chemical compositions, dimensions, orders, temperatures and inclinations, which are overlapped and mounted in a fixed structure (3) or a structure coupled to a mechanical, electromechanical or any other actuation device (4) equipped with means for adjusting the inclination and spacing of the lenses (L) to optimize capture, magnification and projection of the entire electromagnetic radiation (R) from an artificial source or the sun; this structure (3) also includes a driving system (5) actuated by sensors (S) that read the best inclination of the sun rays or any other electromagnetic radiation, following the Earth's rotation in relation to the sun, and allowing energy to be captured, magnified and projected more efficiently.

The present invention relates to a concentration device comprising different combinations and arrangements of thin lenses combined as a compound lens, designed to converge, direct and amplify the intensity of sunrays, light beams from artificial sources, or any electromagnetic radiation, amplifying the intensity of radiation passing through the first lens of the compound, and so on through successive lenses.

### BACKGROUND

It is currently known that capturing solar energy brings numerous benefits, such as reducing the use of fossil fuels and thereby reducing carbon dioxide emissions.

For this purpose, solar thermal collectors are used as an alternative for generating clean energy, as they collect photons from sunlight by means of solar panels, mirrors or lenses, and convert the energy from sunlight into electricity.

Such solar thermal collectors are installed in solar power plants for transforming solar energy into thermal energy in order to obtain electrical energy.

The main drawback of current solar thermal collectors is associated with the fact that they require a great number of mirrors or lenses for collecting or concentrating solar energy, which in turn demands great investment and a lot of space for their installation in solar power plants.

Another drawback is due to the fact that the heat generated by a conventional solar thermal collector is limited with respect to the surface area of its mirrors, panels or lenses.

Another drawback of current solar thermal collectors is that they depend on sunlight in order to work. Consequently, they are not functional at night, nor can they operate during cloudy or rainy days.

Also currently employed are jet turbines that use fuels to heat air in combustion chambers. Their main drawback is the fact that they require a fuel in order to heat the compressed air.

Industrial furnaces and boilers are also used to heat materials that are subsequently transformed, but they inconveniently use great amounts of fuels to burn and heat such materials.

There are also laser cutting machines that use heated light beams to cut many different materials. However, these machines entail high production costs and energy consumption.

### PRIOR ART

A search through specialized databases has found disclosures of solar panels, such as document no. CN 202564381, which relates to a solar energy photovoltaic panel steering mechanism. The mechanism disclosed by this document comprises a photovoltaic panel and a tracking steering mechanism, wherein the photovoltaic panel comprises a foundation, the tracking steering mechanism comprises a worm gear and a worm, the foundation is connected with the worm gear, and the worm gear and the worm are engaged.

Prior art document no. US 2010288332 discloses a solar photovoltaic concentrator panel comprising a Fresnel lens concentrator which may be arched and a photovoltaic receiver within a container comprising a top window. The lens, photovoltaic cell, and window may be affixed in a container with no internal sun-tracking mechanisms or related internal moving parts such as motors, drive systems, or bearings. The window is transparent and the bottom of the container typically dimensioned and configured as a heat exchanger to passively dissipate waste heat from the photovoltaic receiver to the ambient environment. The Fresnel lens concentrator is typically a free-standing Fresnel lens concentrator disposed within the container at a fixed position relative to an interior dimension of the container, optically forming a focal region of concentrated sunlight. The photovoltaic receiver comprises a photovoltaic cell or group of such cells disposed within the container and attached to the bottom at a fixed position relative to an interior dimension of the container to maintain alignment of a predetermined portion of the photovoltaic receiver within the focal region of the free-standing Fresnel lens concentrator.

### BRIEF DESCRIPTION OF THE INVENTION

Aiming to bring improvements to the consumer market, the Applicant has developed a device for concentrating energy from sunrays, artificial light beams or any electromagnetic radiation.

Said energy concentration device comprises different combinations and arrangements of two or more lenses that amplify and direct light or electromagnetic radiation in general, wherein the lenses can have various shapes, chemical compositions, dimensions, arrangements, temperatures and inclinations.

The overlap of a set of two or more lenses causes the convergence of light beams or electromagnetic radiation from solar or artificial sources, amplifying their intensity and heat, and directing them.

For a better efficiency of the lenses, a single lens may be cooled in order to have its temperature reduced. Alternatively, two or more lenses from the compound lens may have their temperatures reduced by cooling.

A component made of reflective material may be placed after the rearmost lens in order to direct the light beams or electromagnetic radiation.

The set of two or more lenses may be assembled in a fixed structure or in a mechanical, electromechanical or another device provided with regulating means that are able to adjust the inclination of the lenses and the distance therebetween, thereby optimizing the efficiency and effectiveness of the collection, absorption, amplification and projection of the light beams or electromagnetic radiation, increasing or decreasing its heat.

The device for concentrating sunlight or the light from an artificial source or electromagnetic radiation in general may also comprise a motion system actuated by sensors that enable a detection of the optimal inclination of the light beams by following the rotation of the Earth with respect to the sun, thereby allowing sunrays to be captured, amplified and projected more efficiently.

### BRIEF DESCRIPTION OF THE DRAWINGS

A more complete understanding of the present invention may be achieved upon reading the detailed description of preferred embodiment that follows, provided as an illustrative and non-limiting aid to understanding, with reference to the appended drawings, in which:

FIG. 1 is a schematic view showing one of the possible arrangements of the lenses comprised by the energy concentration device;

FIG. 2 is a schematic view showing the motion of the panel that concentrates energy from light beams according to the present invention; and

FIG. 3 is a view showing many different shapes for the lenses.

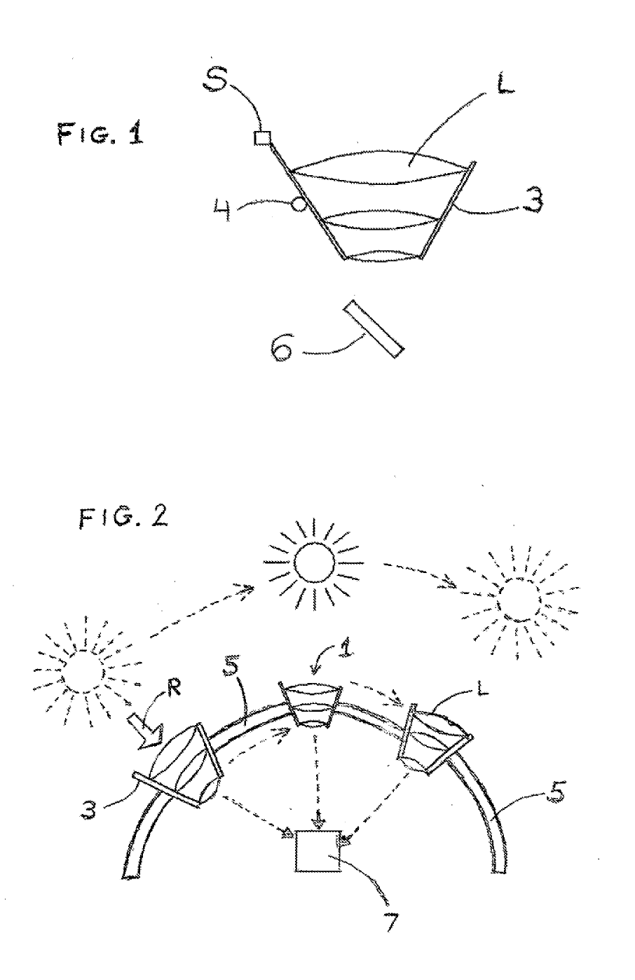

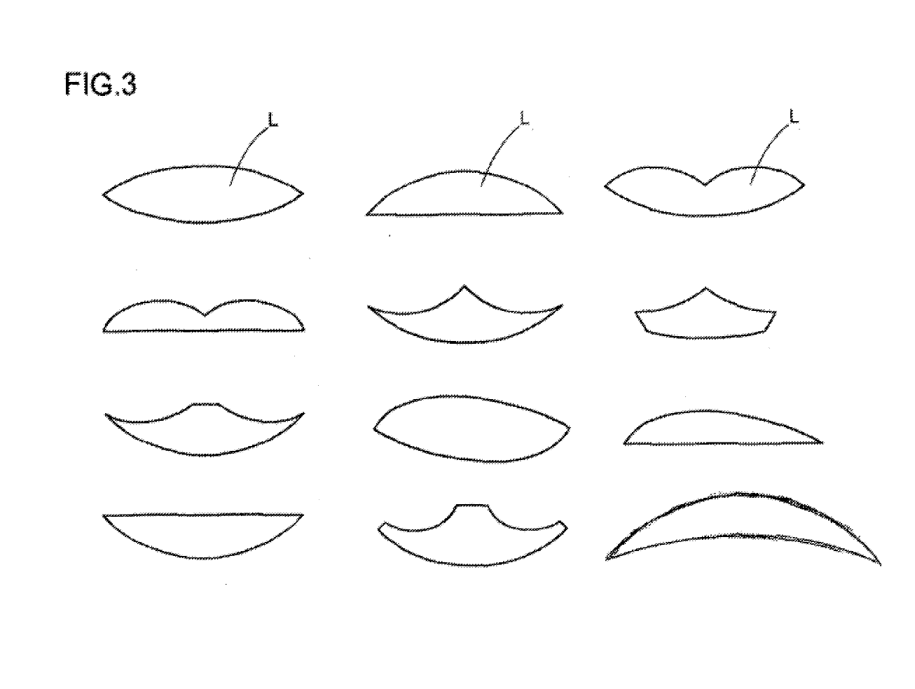

### DETAILED DESCRIPTION OF PREFERRED EMBODIMENTS

With reference to the drawings, the present invention relates to a device for concentrating energy from sunrays, artificial light beams or electromagnetic radiation, more precisely an energy concentration device (1) for the collection, absorption, amplification and projection of light beams or electromagnetic radiation from solar or artificial sources.

According to the present invention, said energy concentration device (1) comprises different combinations and arrangements of two or more overlapped lenses (L) that are assembled in a structure (3) in which an actuating device (4) is provided. Said actuating device (4) may be mechanical, electromechanical, hydraulic or otherwise, and is equipped with regulating means to adjust the inclination and distance between the lenses (L) for an optimal absorption, concentration and projection of an electromagnetic radiation (R) from an artificial or solar source. Said structure (3) may also comprise a motion system (5) actuated by sensors (S) that detect the ideal inclination of the light beams as they follow the rotation of the Earth with respect to the sun, thereby allowing sunrays to be captured, amplified and projected more efficiently into the material (7) or surface to be heated.

In a preferred embodiment, said lenses (L) are lenses that magnify and direct light or electromagnetic energy and have various shapes, chemical compositions, dimensions, arrangements, temperatures and inclinations, and are in addition made of glasses, refractory glasses, tempered glasses, glass-ceramics, fused quartz, or any other kind of transparent or colored material that fulfills the function of magnifying or directing light beams from any portion of the spectrum or any electromagnetic radiation.

In an alternative embodiment, said set of two or more lenses (L) comprises a reflective material (6) arranged after the rearmost lens, in order to direct the light beams or electromagnetic radiation.

Said lenses (L) may have their temperatures reduced, by the cooling of a single lens or, alternatively, of two or more lenses of the energy concentration device.

One skilled in the art will understand that a number of variations may be made in the disclosed embodiments as regards details of construction and form, without departing from the scope or essential principles of the invention as clearly defined by the appended claims. Accordingly, the terminology used herein shall be interpreted as illustrative and not in a limiting sense.

1-6. (canceled)

7. An energy concentration device (1) for collecting, absorbing, magnifying and projecting light beams or any radiation from artificial or natural sources, wherein said device comprises the superposition of two or more lenses (L) that are able to magnify and/or direct energy, so that the electromagnetic radiation passing through the first lens is projected onto the second lens, and so on successively, and said lenses may have different shapes, chemical compositions, dimensions, arrangements, temperatures and inclinations.

8. The device of claim 7, wherein said lenses (L) are made from glasses, refractory glasses, tempered glasses, glass-ceramics, fused quartz, or any other kind of transparent or colored material.
